(19) United States
(12) Patent Application Publication
(10) Pub. No.: US 2009/0147762 A1
(43) Pub. Date: Jun. 11, 2009

(54) TRANSMITTER AND DATA TRANSMISSION METHOD

(75) Inventors: Bao-Chi Peng, Taipei City (TW); Shen-Fu Tsai, Kaohsiung City (TW); Ganning Yang, Irvine, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/952,394

(22) Filed: Dec. 7, 2007

(51) Int. Cl. H04B 7/216; H04L 27/04

(52) U.S. Cl. 370/342; 375/300

(57) ABSTRACT

A method and apparatus for data transmission are provided. Data values of a plurality of channels are transformed into a transmission signal. An enhanced shaping filter is provided to shape a binary stream of only single digits and generate a shaped signal. A weighting unit is coupled to the output of the shaping filter, weighting the shaped signal to effectively generate a quality baseband signal. The binary stream is converted from the data values through spreading and scrambling. A scrambling unit, scrambles the binary stream with scrambling codes. A spreading unit spreads the binary stream at a chip rate before sending the binary to the scrambling unit.

### BACKGROUND OF THE INVENTION

1. Field of the Invention

The invention relates to wide band code division multiple access (WCDMA) transmitters, and more particularly, to a cost effective physical layer architecture for a WCDMA transmitter.

2. Description of the Related Art

FIG. 1 shows the architecture of a conventional transmitter according to the 3rd Generation Partnership Project (3GPP). Data is typically transmitted in three stages. Data streams #TS of various transport channels such as DCH and RACH, are first multiplexed and encoded in parallel by transport layer module 110 to generate a binary stream #BRP, such as DPDCH and DPCCH. Specifically, the binary stream #BRP, comprises in phase and quadrature parts of each transport channel. The binary stream #BRP is then spectrum spread and modulated into a baseband signal #BB in the baseband module 120. The RF module 130 up converts the baseband signal z into a RF signal #RF for transmission via the antenna 140. Generally, the baseband signal z output from the baseband module 120 must be high quality for reducing design cost and power consumption of RF module 130. The quality of baseband signal #BB is typically measured by error vector magnitude (EVM), the emission spectrum and the adjacent channel leakage ratio (ACLR).

FIG. 2 shows a recommended architecture of the baseband module 120 according to 3GPP. The spreading unit 202 spreads the bandwidth of the binary stream #BRP according to a chip rate parameter c, and generates a binary stream #BIN having the chip rate c (3.84 MB for 3GPP).

In the weighting unit 204, data values in the binary stream #BIN are individually weighted by corresponding gain factors β before outputting a weighted stream. The scrambling unit 206 then scrambles the weighted stream by predefined scrambling codes to generate a scrambled stream, and the shaping filter 208 shapes the scrambled stream with roll-off α=0.22 in the frequency domain. According to 3GPP recommendations, the impulse response RC₀(t) of the shaping filter 208 is:

$${RC}_{0} ( t ) = \frac{sin ( π \frac{t}{{T}_{C}} ( 1 - α ) ) + 4 α \frac{t}{{T}_{C}} cos ( π \frac{t}{{T}_{C}} ( 1 + α ) )}{π \frac{t}{{T}_{C}} ( 1 - {( 4 α \frac{t}{{T}_{C}} )}^{2} )} \qquad ( 1 )$$

Where the roll-off factor α=0.22 and the chip duration is

$$T = \frac{1}{chiprate} \approx 0.26042 µs \qquad ( 2 )$$

The baseband signal #BB is thus generated from the shaping filter 208 for further procedures in RF module 130. It is noted that all data values in the binary streams #BRP and #BIN are single digits 0, +1 or −1. The gain factor β may range from 0 to 1 with a 1/15 step size, thus, the weighting unit 204 outputs soft values by multiplication of the binary stream #BIN and the gain factor that are then processed in the scrambling unit 206 and shaping filter 208.

The advantage of the described architecture is the natural-ramping effects of the shaping filter 208 shape harmonics caused by transitions of the gain factors. The variety of the values input to the shaping filter 208, however, is limited by the bit-width of the gain factors β. To improve signal quality, the bit-width and number of taps of the shaping filter 208 are typically large. Although the power consumption of the baseband module 120 is greatly reduced due to improved process technologies, the complexity of the shaping filter 208 hinders reduced cost and power consumption. The shaping filter 208 is typically the dominant component in baseband module 120. Because power consumption of the mobile device is critical, reduced complexity and power consumption of the pulse shaping filter is desirable.

### BRIEF SUMMARY OF THE INVENTION

The invention provides a transmitter and a data transmission method. An exemplary embodiment of a transmitter transforms data values of a plurality of channels into a transmission signal. An enhanced shaping filter shapes a binary stream of only single digits. With an impulse response, a shaped signal is generated and sent to a weighting unit. The binary stream is converted from the data values through spreading and scrambling. A scrambling unit scrambles the binary stream with scrambling codes. A spreading unit spreads the binary stream at a chip rate before being sent to the scrambling unit.

The transmitter may further comprise a weighting unit, weighting the shaped signal by a series of gain factors each corresponding to a channel to generate a baseband signal. The baseband signal is then up converted to the transmission signal by an RF module.

A ramping controller coupled to the weighting unit for providing ramping control for the series of gain factors is further provided. The ramping control may be enabled when a gain factor is changed at a frame boundary. When the ramping control is enabled, the ramping controller smoothens value transition of the gain factor within a brief period before and after the frame boundary, such that harmonics induced in the output of weighting unit can be reduced.

The transmitter may also comprise a transport layer module as conventional ones, multiplexing and encoding data values of the channels to generate the binary stream. Some embodiments adopt WCDMA standard specifically, but the invention is not limited to this. The channels are particularly referred to DPDCH, DPCCH and HS-DPCCH channels. The shaping filter is a simplified SRRC filter capable of processing only single digits 0, +1 and −1.

Some embodiments provide a data transmission method implemented by the described transmitter, and a detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a conventional transmitter architecture according to the 3rd Generation Partnership Project (3GPP); and

FIG. 2 shows a recommended architecture of baseband module 120 according to 3GPP;

FIG. 3 shows an embodiment of an enhanced baseband module 120 comprising a shaping filter 300 and a ramping controller 320;

FIG. 4 shows an embodiment of ramping control of the transients of gain factors: and

FIG. 5 is a flowchart of baseband signal modulation before RF transmission.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

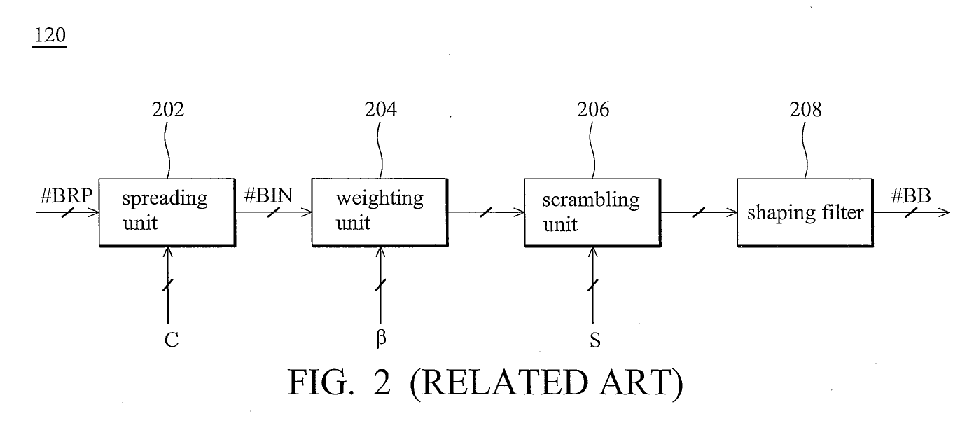

In the conventional baseband module 120 of FIG. 2, the binary stream #BIN is weighted by the gain factors β prior to being shaped by the shaping filter 208. Under such arrangement, the bit-widths of the shaping filter 208 are restricted by the weighted value, the gain factors β. It makes the implementation of the shaping filter 208 very difficult. For example, the conventional shaping filter 208 must implement multipliers to handle non-integer weighted values. The shaping filter 208 is typically a Square Root Raised Cosine (SRRC) filter performing real-coefficient complex-data filtering. The gain factors β range from 0 to 1 with a 1/15 step size. The weighted values sent to the shaping filter 208 are referred to as soft values. The operation performed by the baseband module 120 can be expressed as:

z=(β_{d}c_{d}d_{d}+jβ_{c}c_{c}d_{c})S_{c} [symbol] RC₀(t) (3)

where z refers to the baseband signal output from the shaping filter 208. RC₀(t) is the impulse response defined in equation (1). β_{c} and β_{d} are the gain factors corresponding to DPDCH and DPCCH channels, and c_{c} and c_{d} are their chip rates respectively. d_{c} and d_{d} represent in phase and quadrature parts of the binary streams #BRP, having values of either 0, +1 or −1. S_{c} is the predefined scrambling code.

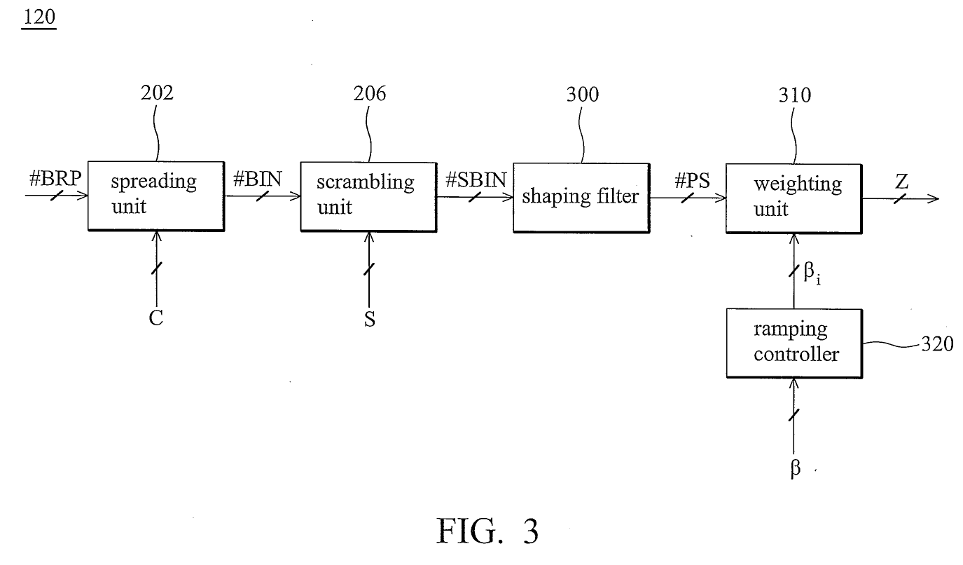

FIG. 3 shows an embodiment of the present invention showing an enhanced baseband module 120 comprising a shaping filter 300 and a ramping controller 320. The enhanced baseband module 120 performs an operation equivalent to the equation (3) expressed as:

z=β_{d}(c_{d}d_{d}S_{c} [symbol] RC₀(t))+jβ_{c}(c_{c}d_{c}S_{c} [symbol] RC₀(t)) (4)

According to equation (4) and FIG. 3, specifically, the weighting operation is performed after the pulse shaping operation, thus, the pulse shaping operation benefits from simplified inputs. When the binary stream #BRP is input to the spreading unit 202, it is spread at the chip rates c_{c} and c_{d}. Then, a binary stream #BIN comprising data streams at those chip rates is output from the spreading unit 202. Thereafter, a scrambling unit 206 scrambles the binary stream #BIN with scrambling codes S_{c} and outputs a scrambled result to the shaping filter 300. Because the scrambled result comprises only simple signed digits 0, +1 or −1, the bit-widths of the shaping filter 300 are reduced, and the implementation of shaping filter 300 can be greatly simplified. In this way, the spreading unit 202, scrambling unit 206 and shaping filter 300 operating in conjunction effectively generate a shaped signal #PS of simple digits, and the weighting unit 310 then weights the shaped signal #PS by the series of gain factors β_{c} and β_{d} respectively to generate the baseband signal z.

The conventional weighting unit 204 in FIG. 2 renders harmonic side effects that are coincidentally alleviated by the ramping effect of the shaping filter 208 while shaping the pulse. In the embodiment of the present invention shown in FIG. 3, however, the output of weighting unit 310 may not be supported by any ramping control. To avoid the harmonic side effects induced by the weighting unit 310, a ramping controller 320 may be further provided to smoothen the transition of the gain factors.

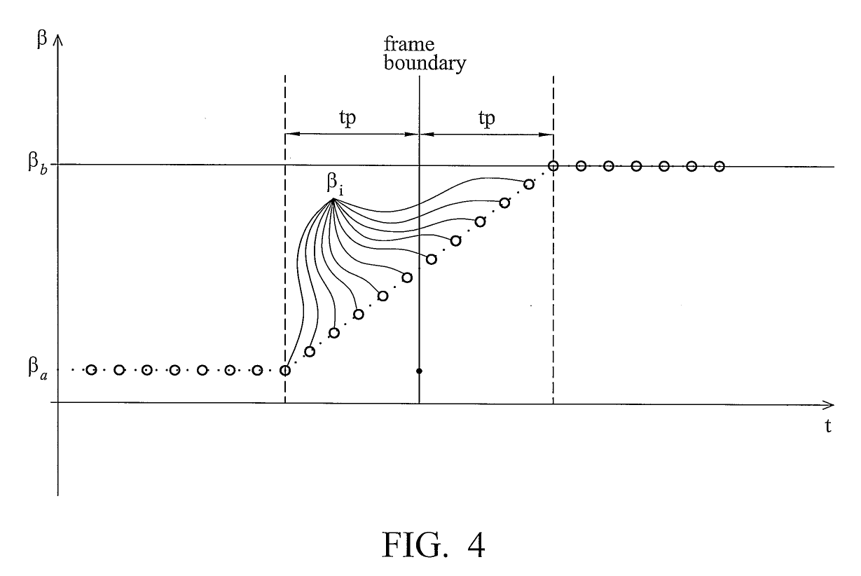

FIG. 4 shows an embodiment of the present invention with ramping control of the transients of gain factors. The ramping control is enabled whenever the gain factors are to be changed, i.e. at a frame boundary. In FIG. 4, a gain factor is changing from an initial value βₐ to a destination value β_{b}. For ramping control issue, it is unnecessary and inefficient to reproduce the natural ramping profile as provided in the conventional shaping filter 208. In the embodiment of the present invention, a linear ramping profile is provided for ramping control. In this embodiment, the ramping controller 320 smoothens value transition of the gain factor within a period tₚ before and after the frame boundary. The intermediate gain factors βᵢ corresponding to i points during the periods tₚ+tₚ may be calculated by linear interpolations of the initial value βₐ to the destination value β_{b}. For example, the brief period tₚ may be 10 μs, and the number i may be 64. Thus, through ramping control of the ramping controller 320, the gain factor βₐ changes incrementally to β_{b} with 64 steps within 20 μs at the frame boundary, and the harmonic side effects are effectively alleviated.

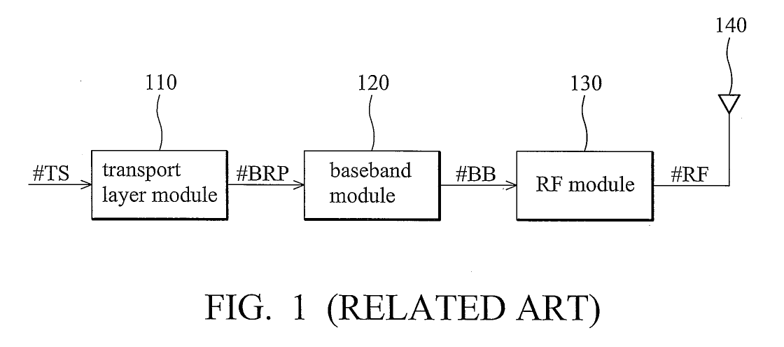

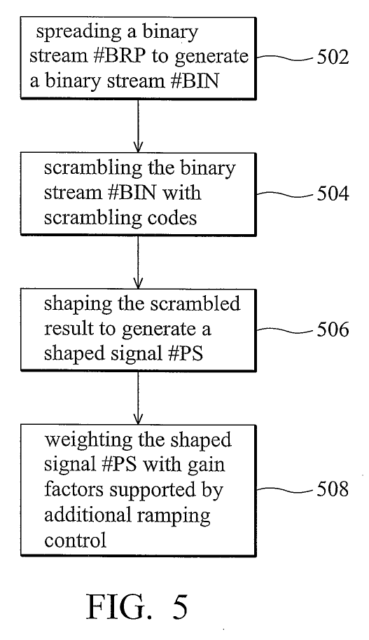

FIG. 5 is a flowchart of baseband signal modulation before RF transmission. In step 502, a binary stream #BRP is spectrum spread at predefined chip rates to generate a binary stream #BIN. In step 504, the binary stream #BIN is scrambled with scrambling codes. In step 506, the scrambled result is shaped by an impulse response to generate a shaped signal #PS. Since the scrambled result comprises only single digits, the complexity for implementing the shaping filter 300 is significantly reduced, as well as power consumption and costs. In step 508, the weighting operation is performed after the shaped signal is generated, and the gain factors are supported by additional ramping control to avoid harmonic side effects. A transmitter adopting the WCDMA standard, however, is given as an example and is intended to be limiting of the invention. The binary stream #BRP may represent a general term of data values of various channels such as DPDCH, DPCCH and HS-DPCCH and #BIN comprises in phase and quadrature parts. The shaping filter 300 in this embodiment is a simplified SRRC filter capable of processing only single digits 0, +1 and −1, however, other filters, such as finite impulse response (FIR) filters, can be used. In this embodiment the transmitter may further comprise a transport layer module 110 and a RF module 130 as shown in FIG. 1 detailed descriptions of which are omitted as they are conventional components.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A transmitter, transforming data values of a plurality of channels into a transmission signal, comprising a shaping filter dedicated to shaping a binary stream with an impulse response to output a shaped signal, wherein the binary stream is converted from the data values, comprising only single digits 0, +1 and −1.

2. The transmitter as claimed in claim 1, further comprising a weighting unit coupled to the output of shaping filter, weighting the shaped signal by a series of gain factors, each corresponding to a channel to generate a baseband signal.

3. The transmitter as claimed in claim 2, further comprising an RF module coupled to the output of weighting unit, up converting the baseband signal into the transmission signal.

4. The transmitter as claimed in claim 2, further comprising a ramping controller coupled to the weighting unit, providing the series of gain factors to the weighting unit with a ramping control, wherein the ramping control is enabled when a gain factor is changed at a frame boundary.

5. The transmitter as claimed in claim 4, wherein when the ramping control is enabled, the ramping controller smoothens value transition of the gain factor within a brief period before and after the frame boundary.

6. The transmitter as claimed in claim 1, further comprising:
a scrambling unit, coupled to the input of the shaping filter, scrambling the binary stream with scrambling codes before sending the binary stream to the shaping filter; and
a spreading unit, coupled to the input of the scrambling unit, spreading the binary stream at a chip rate before sending to the scrambling unit.

7. The transmitter as claimed in claim 6, further comprising a transport layer module coupled to the input of the spreading unit, multiplexing and encoding data values of the channels to generate the binary stream.

8. The transmitter as claimed in claim 7, wherein the transmission signal conforms to the WCDMA standard, and the channels comprise DCH and RACH channels.

9. The transmitter as claimed in claim 1, wherein the shaping filter is a simplified SRRC filter capable of processing only single digits 0, +1 and −1.

10. A data transmission method, transforming data values of a plurality of channels into a transmission signal, comprising shaping a binary stream with an impulse response to output a shaped signal, wherein the binary stream is converted from the data values, comprising only single digits 0, +1 and −1.

11. The data transmission method as claimed in claim 10, further comprising weighting the shaped signal by a series of gain factors each corresponding to a channel to generate a baseband signal.

12. The data transmission method as claimed in claim 11, further comprising up converting the baseband signal into the transmission signal.

13. The data transmission method as claimed in claim 11, further comprising providing the series of gain factors with a ramping control, wherein the ramping control is enabled when a gain factor is changed at a frame boundary.

14. The data transmission method as claimed in claim 13, further comprising when the ramping control is enabled, smoothening value transition of the gain factor within a brief period before and after the frame boundary.

15. The data transmission method as claimed in claim 10, further comprising:
scrambling the binary stream with scrambling codes before the shaping step; and
spreading the binary stream at a chip rate before the scrambling step.

16. The data transmission method as claimed in claim 15, further comprising multiplexing and encoding data values of the channels to generate the binary stream.

17. The data transmission method as claimed in claim 16, wherein the transmission signal conforms to WCDMA standard, and the channels comprise DCH and RACH channels.

18. The data transmission method as claimed in claim 10, wherein the shaping step comprises using a SRRC algorithm to filter input values of only single digits 0, +1 and −1.

19. A transmitter, transforming digital data from a plurality of channels into a transmission signal, comprising:
a SRRC shaping filter, shaping the digital data with an impulse response to output a shaped signal, wherein the digital data are combinations of only 0, +1 and −1;
a weighting unit, coupled to the output of SRRC shaping filter, weighting the shaped signal by a series of gain factors, each corresponding to one of the channels to generate a baseband signal;
an RF module, coupled to the output of weighting unit, up converting the baseband signal into the transmission signal;
a scrambling unit, coupled to the input of the SRRC shaping filter, scrambling the digital data with scrambling codes before sending to the SRRC shaping filter;
a spreading unit, coupled to the input of the scrambling unit, spreading the digital data at a chip rate before sending to the scrambling unit; and
a transport layer module, coupled to the input of the spreading unit, multiplexing and encoding digital data of the channels before sending to the spreading unit;
the channels comprise DPDCH, DPCCH and HS-DPCCH channels.

20. A data transmission method for a transmitter, transforming digital data of a plurality of channels into a transmission signal, comprising:
multiplexing and encoding the digital data from the plurality of channels;
spreading the digital data at a chip rate after multiplexing and encoding;
scrambling the digital data with scrambling codes after spreading;
shaping the scrambled digital data using a simplified SRRC shaping filter to generate a shaped signal, wherein the data values are a combination of only 0, +1 and −1;
weighting the shaped signal by the series of gain factors to generate a baseband signal; and
up converting the baseband signal into the transmission signal.
